(19) United States
(12) Patent Application Publication
(10) Pub. No.: US 2017/0124448 A1
(43) Pub. Date: May 4, 2017

(54) CONCURRENT UNCERTAINTY MANAGEMENT SYSTEM

(71) Applicants: STEPHEN J. ENGEL, EAST NORTHPORT, NY (US); ELIAS L. ANAGNOSTOU, MERRICK, NY (US); JERRELL A. NARDIELLO, HICKSVILLE, NY (US); JOHN S. MADSEN, COMMACK, NY (US)

(72) Inventors: STEPHEN J. ENGEL, EAST NORTHPORT, NY (US); ELIAS L. ANAGNOSTOU, MERRICK, NY (US); JERRELL A. NARDIELLO, HICKSVILLE, NY (US); JOHN S. MADSEN, COMMACK, NY (US)

(73) Assignee: NORTHROP GRUMMAN SYSTEMS CORPORATION, FALLS CHURCH, VA (US)

(21) Appl. No.: 14/928,190

(22) Filed: Oct. 30, 2015

(51) Int. Cl. G06N 3/04; G06N 3/08; G01M 99/00

(52) U.S. Cl. CPC G06N 3/0472; G01M 99/008; G06N 3/08

(57) ABSTRACT

A system includes a physical layer that a plurality of data structures that represents a plurality of physical input data associated with product materials, assemblies, and operational use of a product of interest over various stages of product lifetime. The system includes reasoning model layer to process the data structures for the respective product stages to determine uncertainty descriptor data (UDD) for each product stage. The system includes a propagation layer that employs a plurality of virtual models that electronically describe each stage in the plurality of product stages with the UDD from each stage and propagates the UDD from each updated virtual model from each product stage between each of the plurality of virtual models across a network to mitigate compounding of error estimates across each product stage of the product lifetime to provide a product lifetime estimate.

### TECHNICAL FIELD

This disclosure relates to lifecycle management systems, and more particularly to a concurrent uncertainty management system.

### BACKGROUND

Lifecycle management is the process of managing the entire lifecycle of a product from inception, through engineering design and manufacture, to service and disposal of manufactured products. The core of lifecycle management is in the creation and central management of all product data and the technology used to access this information and knowledge. Some of the main areas of lifecycle management include conception (e.g., specification, concept design), design (e.g., detailed design, validation and analysis), realization (e.g., manufacture, assembly, test), and service (e.g., product use, maintenance, and support). Lifecycle management as a discipline emerged from tools such as computer aided design (CAD), computer aided manufacturing (CAM), and product data management (PDM), for example, but can be viewed as the integration of these and other tools.

Many software components have been developed to organize and integrate the different phases of a product's lifecycle. Thus, lifecycle management is typically not provided via a single software product but rather a collection of software tools and working methods integrated together to address either single stages of the lifecycle, to connect different tasks, or to manage the entire process. Some software providers cover the whole lifecycle management range while others offer single niche applications. One issue with existing systems and modules that comprise the software system is that individual components of the system tend to operate in isolation and in a deterministic manner with respect to estimation of risk associated with components, modules, assemblies of a product through how a product is eventually used and deployed. For example, safety factors such as component tolerances and material strength and fatigue after use exist separately in the various engineering, maintenance, and sustainment groups supporting the lifecycle of the system. By analyzing such factors in isolation at each stage however, these factors are unwittingly compounded to such a degree as to be inefficient and can lead to premature retirement of assets that actually have significant remaining useful life.

### SUMMARY

This disclosure relates to a concurrent uncertainty management system where uncertainty data is processed at each stage of a product lifecycle and propagated throughout the system to mitigate compounding of risk factors from each stage and to increase end product lifetime. In one aspect, a system includes one or more computers executing computer executable components. The computer executable components include a physical layer that aggregates a plurality of data structures that represents a plurality of physical input data associated with product materials, assemblies, and operational use of a product of interest. The plurality of data structures include data structures for each of a design stage, a manufacturing stage, and a sustainment stage, the physical input data associated with each stage contributing to define an operational lifetime of a product. A reasoning model layer processes the data structures for the respective products stages to determine uncertainty descriptor data (UDD) for each product stage. The UDD defines an uncertainty probability estimate for each of the physical inputs in the plurality of data structures, where the uncertainty probability estimate relates to the probability of error within each stage of the product lifetime. A propagation layer employs a plurality of virtual models that electronically describe each stage in the plurality of product stages with the UDD from each stage. The propagation layer propagates the UDD from each updated virtual model from each product stage between each of the plurality of virtual models across a network to mitigate compounding of error estimates across each product stage of the product lifetime to provide a product lifetime estimate.

In another aspect, a method includes receiving a plurality of data structures that represents a plurality of physical input data associated with product materials, assemblies, and operational use of a product of interest. The plurality of data structures include data structures for each of a design stage, a manufacturing stage, and a sustainment stage, where the physical input data associated with each stage contributes to define an operational lifetime of a product. The method includes applying a respective reasoning model to the data structures for the respective products stages to determine uncertainty descriptor data (UDD) for each product stage. The UDD defines an uncertainty probability estimate for each of the physical inputs in the plurality of data structures. The uncertainty probability estimate relates to the probability of error within each stage of the product lifetime. The method includes updating a plurality of virtual models that electronically describe each stage in the plurality of product stages with the UDD from each stage. The method includes propagating the UDD from each updated virtual model from each product stage between each of the plurality of virtual models across a network to mitigate compounding of error estimates across each product stage of the product lifetime.

In yet another aspect, a non-transitory computer readable medium having computer executable instructions configured to process a plurality of physical inputs that define product materials, models, assembly, and use that are converted to a plurality of data structures for each of a plurality of product stages. Each stage in the plurality of product stages contribute to define an operational lifetime of a product, the product operational lifetime includes a conception phase, a design phase, a manufacturing phase, and a sustainment phase. The instructions are configured to apply a respective reasoning model to the data structures for the respective products stages to determine uncertainty descriptor data (UDD) for each product stage. The UDD defines an uncertainty probability estimate for each of the physical inputs in the plurality of data structures. The uncertainty probability estimate relates to the probability of error within each stage of the product lifetime. The instructions are configured to update a plurality of virtual models that electronically describe each stage in the plurality of product stages with the UDD from each stage. The instructions are also configured to propagate the UDD from each updated virtual model from each product stage between each of the plurality of virtual models across a network to mitigate compounding of error estimates across each product stage of the product lifetime. The UDD is propagated via tagged identifiers that describe a common data model structure such that each virtual model can identify each component and process that has changed from at least one other virtual model.

### BRIEF DESCRIPTION OF THE DRAWINGS

FIG. 1 illustrates a block diagram of an example a concurrent uncertainty management system where uncertainty data is processed at each stage of a product lifecycle.

FIG. 2 illustrates an example of a communications framework and modules for a concurrent uncertainty management system.

FIG. 3 illustrates an example of a model processing framework for a concurrent uncertainty management system.

FIG. 4 illustrates an example implementation of a concurrent uncertainty management system where uncertainty data is processed at each stage of a product lifecycle.

FIG. 5 illustrates an example of a method for concurrent uncertainty management where uncertainty data is processed at each stage of a product lifecycle.

FIG. 6 illustrates an example processing framework for a concurrent uncertainty management system where uncertainty data is processed at each stage of a product lifecycle.

### DETAILED DESCRIPTION

This disclosure relates to a concurrent uncertainty management system where uncertainty data is processed at each stage of a product lifecycle and propagated throughout the system to mitigate compounding of risk factors from each stage and to increase end product lifetime. A plurality of physical and virtual models are provided that each account for their own area (domain) of uncertainty where uncertainty descriptor data attributed to each domain is passed between domains via tagged identifiers to other domains in the system such as via a management system network framework. When the overall system uncertainty is accounted for by aggregating the uncertainties across the system, each respective domain of the system can determine probabilistic estimates about their own respective domain and minimize conservative practices within the domain (e.g., liberalize conservative design rules when uncertainty for the entire system was unknown) in view of the known uncertainties. When the uncertainties have been accounted for at each stage of the lifecycle, overall estimates for a product's lifetime can be extended thus providing a substantial economic impact. However, it is noted that while product life extension will be a benefit in most cases, it is possible that for a given vehicle, the life estimate could be less than the design life due to the combination of actual factors related to design, manufacturing, use, and maintenance. Thus, there is a benefit in this case by avoiding unforeseen premature failure that could lead to loss of a vehicle, and worse, loss of life.

The concurrent uncertainty management system (“management system”) reduces respective uncertainty in life expectancy predictions for products (e.g., aircraft, land vehicles) by performing continuous life expectancy predictions for the products based on uncertainty data generated from various phases of a life cycle of a respective product. The phases of a life cycle of the product can include an engineering phase, a manufacturing phase, and a sustainment phase, for example. The uncertainty descriptor data generated at each respective phase provides unique information related to structural aspects of the products during that particular phase. For instance, product error data, product defect data, product sensor data, manufacturing substitution data, can all be monitored and utilized to update the uncertainty descriptor data if deviations from expected uncertainties are encountered.

The management system can be configured to both generate a virtual model representation based on design information from the engineering phase and predict the life expectancy of the product based on a simulation of the virtual model in a virtual environment. The management system can be further configured to utilize the uncertainty descriptor data generated from the manufacturing and sustainment phase to adjust (modify dynamically) the virtual model. Thus, the management system can be configured to update in real-time the virtual model to reflect the real-world product based on respective uncertainty descriptor data from the manufacturing and sustainment phase.

For example, if the product is nonconforming with the virtual model (e.g., the real-world vehicle was manufactured with different material than the virtual model was based on), the management system updates the virtual model to reflect the product deviation based on the uncertainty data from the manufacturing phase. These modifications impact the predicted life expectancy. The management system can be configured to continuously monitor the uncertainty data from the manufacturing phase and provide an updated predicted life expectancy for the product based on a simulation of the updated virtual model in the virtual environment. Similarly, the management system can be configured to monitor the uncertainty data from the sustainment phase (e.g., information such as a flight history of the product or associated products, stresses, strains and temperatures experienced by the product) and provide an updated predicted life expectancy for the product based on a simulation of the updated virtual model in the virtual environment. Thus, the management system enables continuous life expectancy predictions to be made for each product in real-time based on uncertainty data provided from each respective phase of a life cycle of a product. In many cases, by continuously monitoring and updating models based on uncertainty, product lifetime can be extended since uncertainty across the lifetime has been accounted for, where a better understanding of uncertainty allows for more liberal parameter extensions of previous worst-case estimates.

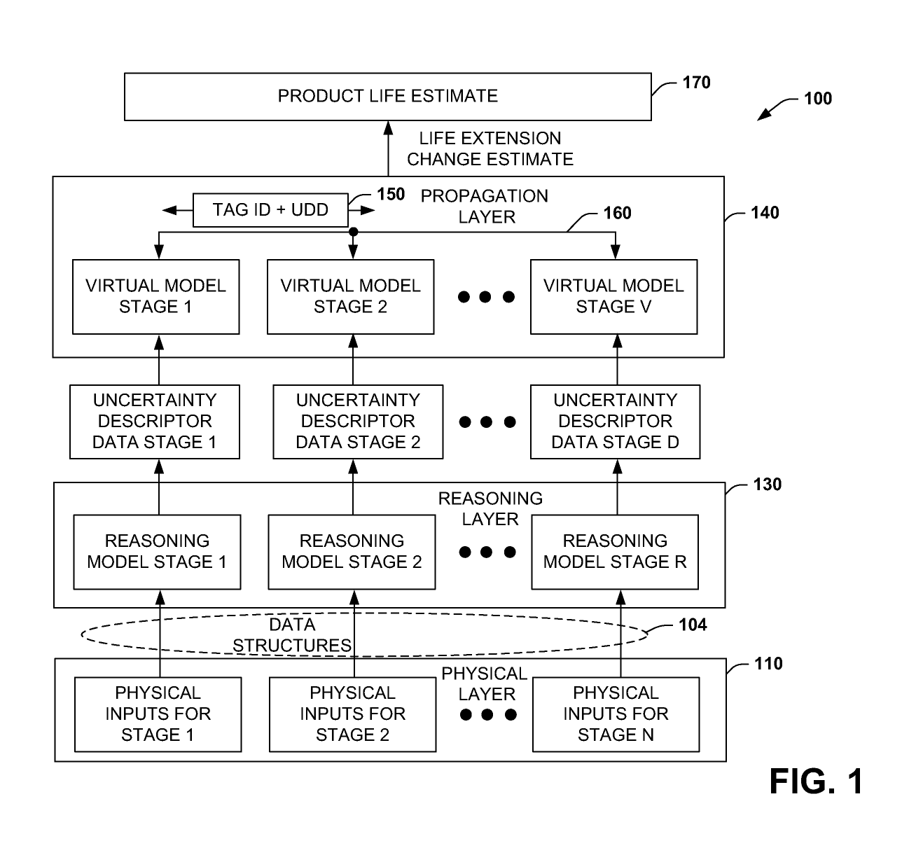

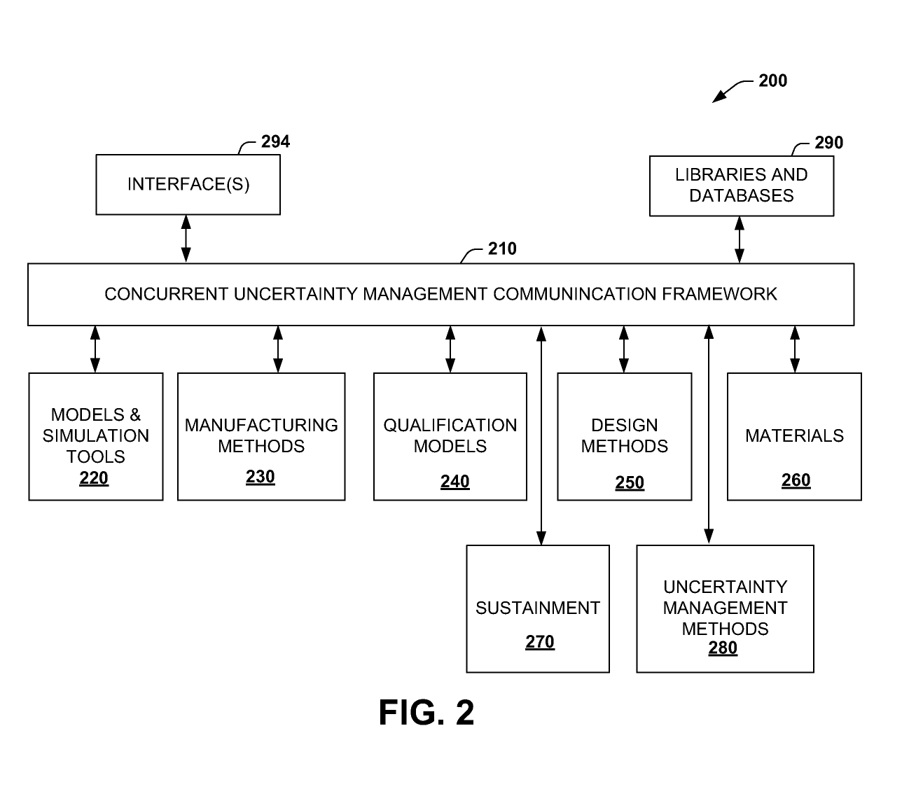

FIG. 1 illustrates a block diagram of an example a concurrent uncertainty management system 100 where uncertainty data is processed at each stage of a product lifecycle. The system 100 includes a physical layer 110 that aggregates data structures 104 from a plurality of physical inputs shown as physical inputs for stage 1, stage 2, and stage N, where N is a positive integer. As used herein, a layer refers to a processing level where computer executable instructions are executed by a processor to perform the tasks of the layer. The physical inputs 110 define product materials, models, assembly materials, practices and procedures, and use (e.g., feedback from flight data recorders and sensors) that are converted to the plurality of data structures 104 for each of a plurality of product stages. The data structures 104 provide a digital capture of data relating to sensed or logged deviations in components, assemblies, manufacturing deviations, product usage deviations, and so forth all which can contribute to lifecycle uncertainties as described herein. Each stage in the plurality of product stages contributes to define an operational lifetime of a product, where the product operational lifetime includes a design stage, a manufacturing stage, and a sustainment stage, for example (See e.g., of FIG. 2 for other example stages).

A reasoning model layer 130 includes reasoning models 1 though R, with R being a positive integer. The reasoning model layer 130 processes the data structures 104 for the respective products stages to determine uncertainty descriptor data (UDD) for each product stage shown as UDD 1 though D, with D being a positive integer. The UDD defines an uncertainty probability estimate for each of the physical inputs 110 in the plurality of data structures 104. The uncertainty probability estimate relates to the probability of error or deviation within each stage of the product lifetime. As used herein, the term product can refer to a component, an assembly, a sub-assembly, and so forth that contribute to collectively perform functions of the product which can include vehicles, aircraft, electronic products, and so forth.

In one example, if a component is substituted in manufacturing and has a different tolerance from that which was originally specified at design, a deviation report can be generated and a data structure 104 populated, where the reasoning model layer 130 can determine a probability estimate in the form of the UDD. A propagation layer 140 employs a plurality of virtual models shown as 1 through V, with V being a positive integer, that electronically (e.g., digital models of materials, assemblies, or systems) describe each stage in the plurality of product stages in view of the UDD from each stage. The propagation layer 140 propagates the UDD from each updated virtual model via tagged identifiers 150 from each product stage between each of the plurality of virtual models 1-V across a network 160 to mitigate compounding of error estimates across each product stage of the product lifetime to provide an extended product lifetime estimate.

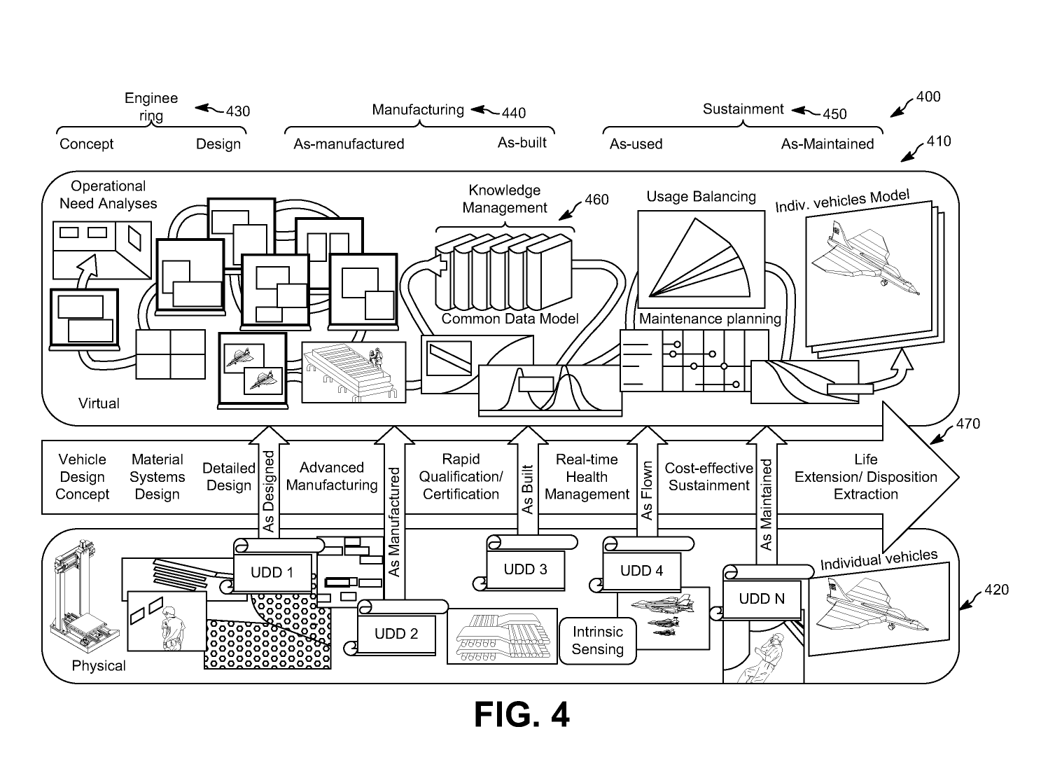

The tagged identifiers 150 represent an update of uncertainty data detected by the reasoning model layer 130 which is subsequently passed to update all virtual models in the system 100. For example, if a component is substituted, the reasoning model layer 130 can indicate which component was changed and an electronic tag can be associated with the changed component such that any upstream or downstream process or assembly which uses the component can have its virtual model updated with a new probability estimate to account for the change. The UDD can be propagated via the tagged identifiers 150 that describe a common data model structure (e.g., See e.g., FIG. 4) such that each virtual model can identify each component and process that has changed from at least one other virtual model. For example, if UDD for virtual model 1 has changed, the tagged identifier 150 can communicate such change to the other virtual models on the propagation layer 130, where each of the other models can update their respective stage or domain based on the changes noted by the tagged identifier. Such processing and communications can include hundreds of thousands of components with each component, assembly, or usage associated with potentially thousands of models. As each virtual model in the propagation layer 140 is updated to account for changes in uncertainty, product lifetime change estimates can be generated by the propagation layer 140 to provide a product lifetime estimate 170 (e.g., extending or reducing lifetime estimate) based on a knowledge of overall and aggregated uncertainty across the system which can allow for liberalization of conventional, compartmentalized, and/or isolated design practices.

The system 100 can employ probabilistic reasoning methods at the reasoning model layer 130 rather than a statistical approach to minimize data needed to account for uncertainties. To capture variability inherent in product attributes such as performance, schedule, cost, and reliability, physics-based models can be employed at the physical layer 110 and the propagation layer 140 to identify pertinent cause and effect relationships and the associated random variables, their interdependencies, and their relative influence on quantities of interest. Physics-based models represent the interaction between concurrent failure modes. High-fidelity modeling can be based on experimental characterization of the pertinent microstructures, where model predictions are continually verified with focused experiments. A common uncertainty format (e.g., tagged identifiers) for statistically representative, digital, microstructure definitions enables rapid and accurate correlation between the various models. Probabilistic methods can also be employed to account for stochastic behavior and for materials variability. Reduced-order (meta-) models can be developed for field use. These surrogate models are updated more frequently as damage progresses and the requirements for uncertainty become more stringent.

A dynamic Bayesian belief network can be employed by the reasoning layer 130, in one example, and can be overlaid on the cause-and-effect structure to propagate dominant uncertainties from their sources to product parameters of interest. Random variable distributions represented at nodes in the network and their associated hyper-parameters can be updated using Bayesian learning methods, for example or other learning systems such as neural networks. A generalized version of probability distribution mapping can be used to propagate the effects of low-probability events. Uncertainty propagation via the determined UDD and tagged identifiers 150 can then be run in reverse to identify the minimum set of targeted, maximally orthogonal tests with the greatest reduction in product uncertainties regarding schedule, performance, cost, and reliability, for example. The result is a set of well-characterized random variables and the means to generate probabilistic certificates of correctness (PCoC), distributions for schedule, cost, performance, and reliability.

In general, the physical layer 110 accepts any deterministic model that produces a state space trajectory of defect size as a function of time/usage. Typically, such models involve an initial state (usually an initial flaw size), an assortment of model parameters (stress intensity factors and so forth) and usage (usually stress history) as inputs, and produce a deterministic trace of defect size evolution as a function of past and anticipated usage as an output. Any of the input variables can take on random values as characterized by probability distribution functions. Each input distribution can (optionally) be characterized by hyper-parameter distributions that can be refined through Bayesian learning at the reasoning model layer 130.

For example, data can be gathered regarding that an input flaw-size distribution is best characterized as a two-parameter Weibull distribution. For instance, different lots may show different values for these two parameters. Consequently, each of the two parameters may also be treated as random variables that may in turn be characterized by their own distributions (that may be jointly distributed). The reasoning models can include a Bayesian learning process that uses data, produced by laboratory experiments or fleet findings, to adjust the hyper-parameters that in turn improve input distributions. Reasoning also incorporates an adaptation method to personalize predictions at the individualized component level.

While input distributions refined by learning methods typically apply to the general population of components at the fleet level, each individual component has its own unique distribution that is refined using sensor data from that particular product/aircraft/component. State awareness sensors at the physical layer 110 can provide either defect detection and/or defect size, for example. Defect detection sensors (e.g., crack, corrosion, delamination sensors) generally are used in the incipient stages where defects are approaching the detection threshold of the sensor. Defect detection sensors can declare that they detect or do not detect a flaw at their detection threshold. Sensors that report defect size are generally useful when the defect is sufficiently large enough to be accurately quantified. All sensors have their associated uncertainties. System adaptation methods can account for the uncertainties in each stage as well as the uncertainties in the model to combine them appropriately to iteratively update failure predictions in the propagation layer 140 and thus correct/extend product lifetime estimate at 170.

The UDD can be updated from various types of uncertainty regarding components, manufacture, or use. Uncertainty exists in three basic forms: aleatoric, epistemic, and prejudicial. Aleatoric uncertainty (also called variability) is the inherent variation in a system that cannot be reduced. For example, components whose health is a function of use (e.g., loads on a structure) require future use information to predict remaining useful life. In most cases, future loads cannot be known exactly. As a consequence, this uncertainty cannot be entirely reduced in advance of actual usage/flight. Epistemic uncertainty usually originates from a lack of knowledge or a potential deficiency that can be corrected in theory—although not always in practice. Epistemic uncertainty is reducible by rectifying the deficiency or through a better characterization of the unknowns. Physics of failure models for example, can be used to provide a better understanding of damage progression thus reducing epistemic uncertainty. Bayesian updating methods can also be used (especially when data are sparse) to adjust assumptions regarding the underlying distributions of random variables based on experiential observations.

Prejudicial uncertainty originates from errors or bias in measurements (e.g., measurement error in sensors). Prejudicial uncertainty is also reducible if the errors can be characterized through controlled testing. Uncertainties in structural health prediction are rooted in many sources, including: the stochastic nature of the damage accumulation process within the material resulting from randomness in its microstructure; imperfect load measuring and its mapping from global kinematic usage sensors to local stresses at fatigue-critical locations; unknown local chemistry; differences between the original test spectrum and the actual flight spectrum; uncertainties in the predictive technology; errors in the fatigue tracking algorithms; sensor errors, missing and corrupted data, and so forth.

FIG. 2 illustrates an example of a communications framework and modules for a concurrent uncertainty management system 200. The system 200 includes a concurrent uncertainty management framework 210 which provides physical input gathering reasoning, network connections, and communication of tagged identifiers to update models with respect to uncertainty descriptor data (UDD). The framework 210 can process data with respect to models and simulation tools at 220 (e.g., structural, process, multi-scale, sensor models, cost models, endurance). Other processing can include manufacturing methods at 230 (e.g., tooling, M&P, assembly) along with qualification models at 240 (e.g., Bayes, analogy, simulation, inspection, targeted tests).

Still yet other framework processing can include design methods at 250 (e.g., manufacturing-informed design optimization (MDO), commercial-off-the-shelf (COTS)) along with materials modeling at 260 (e.g., resins, additives, pre-forms). Sustainment 270 (e.g., logistics, usage data, fleet management) includes analyzing sensor and flight data to determine if uncertainties accounted for in the early design stage models should be adjusted based on actual product usage data. Other framework processing can include uncertainty management methods at 280 (e.g., PDMM, uncertainty propagation, probabilistic certificates, Bayesian learning, sensing, adaptation). As shown, various libraries and databases 290 can interact with the framework 210 (e.g., manufacturing libraries, design libraries, material characterizations, sensor parameters, model parameters, and so forth).

The framework 210 enables the collaborative optimization of materials, manufacturing processes, and computational design to obtain probabilistic predictions of short- and long-term performance and to allow designers to select the most appropriate methodology among multiple processes, optimizing reliability, cost, and schedule at the earliest possible time. This provides a concurrent uncertainty management modeling and simulation toolset by developing a modular “plug and play” software system with the following attributes: integrated, interactive, reconfigurable computational network; hierarchy of models that provide a consistent description of the multiple spatial- and temporal-scale phenomena in materials, processes, and products; adaptive reasoning methods that account for scale and process interactions; efficient computational analysis; representation of uncertainty and its propagation; and probabilistic optimization and control methods. The overall software system of the framework 210 can facilitate interactive collaboration among various users and provide an environment for rapid manufacturing-informed design optimization. The framework 210 can reduce reliance on current trial and error methodology, preventing time- and cost-intensive design revisions and can foster new approaches to composite manufacturing.

The framework 210 can be provided as an enterprise-level framework that serves all product domains from concept requirements to sustainment. To facilitate openness, the framework 210 can employ an “apps oriented” strategy built on a control and communication infrastructure that allows existing and yet-to-be developed software applications to work concurrently. The framework 210 can employ plug-in wrappers for a wide variety of engineering tools, cost estimation models, simulation and visualization software, and optimization algorithms spanning multiple disciplines, for example. The framework 210 controls the invocation of these diverse applications according to a user-specified precedence hierarchy, for example. As shown, one or more user interfaces 294 can be provided to interact with the framework 210. This includes receiving change notifications, updating uncertainties, and providing product lifetime extension/reduction updates to management regarding on-going and automated evaluations of uncertainty across each stage of the product lifetime.

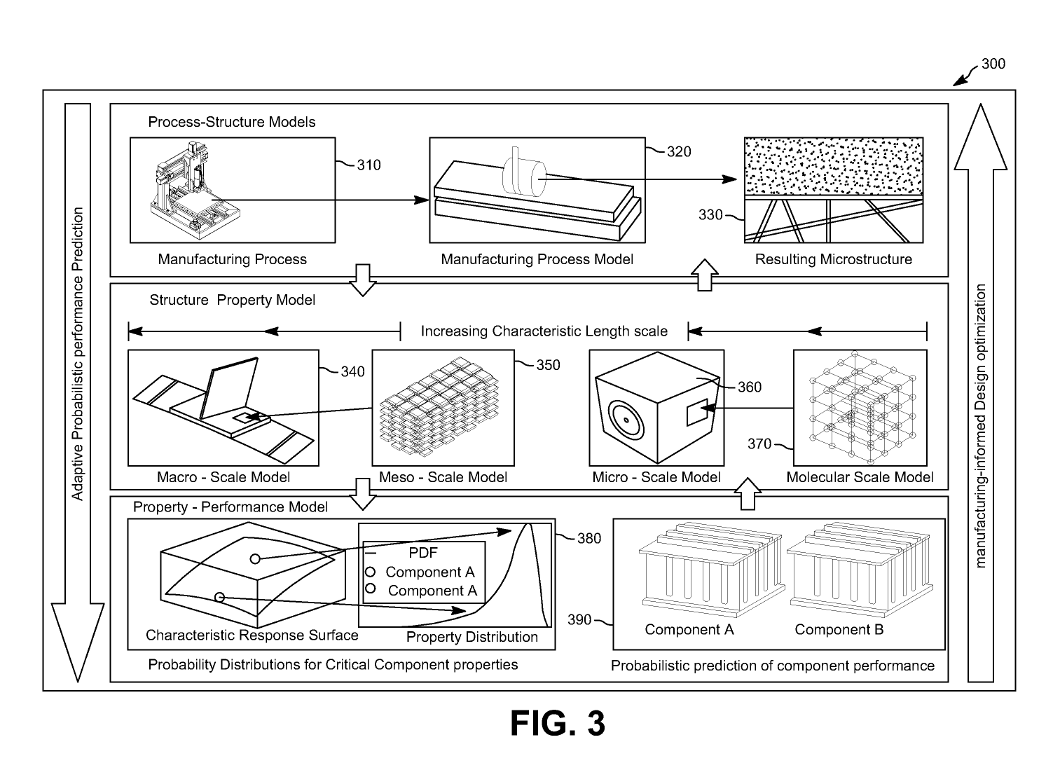

FIG. 3 illustrates an example of a model processing framework 300 for a concurrent uncertainty management system. The framework 300 can include a modeling and simulation framework for virtual models that can be formulated based on the development of an interactive, multi-scale, multi-physics nonlinear coupled manufacturing and design modeling and simulation toolset. These tools can relate the materials and manufacturing processes used to create a component with the reliability, cost, and schedule of the component in its operational environment. The relationship between materials, manufacturing processes, and the component's reliability, cost, and schedule can be established via a hierarchy of modular process-structure-property-performance (P3S) models as illustrated in the framework 300. The modular P3S framework can be built via an open-architecture “plug and play” format, capable of accepting models for new materials and new manufacturing processes. The P3S framework will be realized by developing computational modeling and simulation tools calibrated and validated by experiments, for example.

The first component in the P3S toolset can be a suite of process-structure models 310 that take manufacturing process models 320 and their controllable and random variables as inputs and output the resultant material microstructure at 330. An interactive process design optimization capability will be provided to simulate manufacturing process physics and identify the transport phenomena that surface during the process. An example of one such model is a molecular dynamics (MD) composite cure model that takes the spatial distribution in temperature and pressure from a curing simulation and returns the chemical and rheological characteristics of the matrix material including cure time, porosity, and degree of cross-linking. This can be extended to relate other processes used in the concurrent uncertainty management system, such as adhesive bonding, with evaluation of the essential microstructural parameters (e.g., surface activation, roughness).

The second component in the P3S toolset can be a suite of structure-property models 340 that take the microstructure output from the first step and output the relevant nonlinear material properties. An interactive material design optimization capability can be developed to model the nonlinear micromechanics behavior of composite materials to understand stochastic effects on the microscale; capture physical, statistical and model uncertainties; and predict failure at a sub-ply level at 350 and 360 where a molecular scale model is generated at 370.

These tools entail the probabilistic assessment of composite material properties and provide the capability to compensate for any changes in performance caused by the manufacturing process (e.g., fiber waviness, resin-rich areas) and environmental or usage effects (e.g., hygrothermal effects, impact). In this approach, a finite-element-based multi-scale framework can be used to enable 3-D explicit, realistic, finite element models of a representative volume element (RVE) of a complex multilayer composite microstructure. Actual distributions of the local fields (e.g., stress, strain, temperature) at the microscale can then be computed and used to form an explicit representation of damage initiation and evolution within the RVE. Local fields and damage state variables obtained from the RVE can then be propagated to higher length/temporal scales using a material qualification and characterization (MCQ) module. The MCQ uses a physics-based micromechanics formulation to simulate nonlinear properties of polymer, metal, and composite materials, for example.

Another component of the P3S toolset can be a series of property-performance models 380 that predict component performance in its operational environment. An interactive component design optimization capability can be provided to perform probabilistic structural analysis of the component to determine scatter in failure load and identify stages of damage and fracture evolution and probability of failure at 390. A set of tools (ABAQUS, NASTRAN, HYPERSIZER, and so forth) can be employed for structural design, analysis, and optimization. Material and manufacturing variability and operational/environmental considerations can be incorporated into these commercial software programs. Augmentation of commercial software tools will allow for simulation of a variety of in-service scenarios including static failure, low/high-cycle fatigue, moisture absorption, and time-dependent behavior such as creep. By carrying the influences and variability of materials and manufacturing processes up to the in-service component level, the P3S framework will remove distinctions between the as-designed, as-built, and as-is states of the component, for example.

FIG. 4 illustrates an example implementation of a concurrent uncertainty management system 400 where uncertainty data is processed at each stage of a product lifecycle. The system 400 includes virtual layer 410 that communicates with a physical layer 420. The physical layer communicates uncertainty descriptor data UDD 1 through UDD N to the virtual layer 410. The virtual layer can include an engineering phase 430 (e.g., concept and design), a manufacturing phase 440 (e.g., as-manufactured, as-built) and a sustainment phase 450 (e.g., as-used, as-maintained). The virtual layer 410 can include a common data model 460 which represents all the tagged-data structures defining each component and process in each phase of the product lifetime.

This system 400 provides an extensible, configurable enterprise-level framework that expedites the controlled interplay of data, information, and knowledge among design, manufacturing, operations, and sustainment disciplines that informs decisions throughout a system's life cycle. The individual vehicle digital model is a virtual idealization (surrogate model) of an individual physical vehicle codified as a collection of computer models and data that accurately capture vehicle behavioral responses at multiple spatial and temporal scales in the virtual layer 410. The product/vehicle can be of any type including, but not limited to, air, land, sea, hybrid, so forth. When used to process “as-built”, “as-used”, “as-maintained” and health data as experienced by its physical counterpart, the virtual model faithfully mimics the health state and system response of the real vehicle. The virtual fleet of virtual models and the engineering community that created, interacts with, and maintains them, are connected together by the concurrent uncertainty management system and framework as described herein. The system 400 shows the relationship between the system and digital fleet, and how this reflects the physical world.

More than just the physical means to connect information, it is a system whereby the common interconnected data model 460 allows concurrent engineering and concurrent uncertainty management. Thus, changes made by one discipline can be instantly evaluated by all others using simulations made possible by coupled digital representations of the component/vehicle. The virtual layer 420 represents the virtual world comprised of digital surrogate models, processes, knowledge, engineering disciplines and simulation environments tied together in seamless communication by the concurrent uncertainty management system infrastructure. The physical layer 410 represents the physical world that is emulated by the virtual world.

At 470, various engineering phases are represented throughout the life cycle beginning with conceptual design and ending with the final retirement/disposition of the vehicle. The left side of 470 generally relates to the design phases of the life cycle, while the right side of 470 generally relates to the sustainment phase of the life cycle. Traditionally, these phases are separated by time. In the virtual world, the user is free to explore all phases concurrently via the interfaces previously described. The virtual layer 410 supports the emulation of key vehicle attribute at all stages in the life cycle including the conceptual and operational needs, design tradeoffs, materials selection and qualification, manufacturing, usage, reliability and performance characteristics, maintenance, Service Life Assessment/Service Life Extension Program (SLAP/SLEP) activities, and retirement.

The system 400 enables all these activities to be explored concurrently even before the physical vehicle is built, to both reduce and quantify the uncertainties associated with each step in the life cycle. Emulation doesn't have to end at the design step. The prognostic/probabilistic asset tracking processes, continues updating the digital vehicle model emulation during operations for the benefit of fleet management and sustainment, and feeds information back to the design process to enhance the body of knowledge for future vehicles. Thus, the virtual layer 420 remains in step with the physical layer 410 as the cycle progresses. Data are exchanged in various forms between the physical and virtual worlds as illustrated by the UDD. The system 400 provides many potential benefits from reducing the uncertainty that drives conservatism in the design, materials selection and inspections and so forth, bringing forward the as-built configuration into the digital vehicle model and bringing the realism of manufacturing, operations and sustainment back into the concept and detailed design phases.

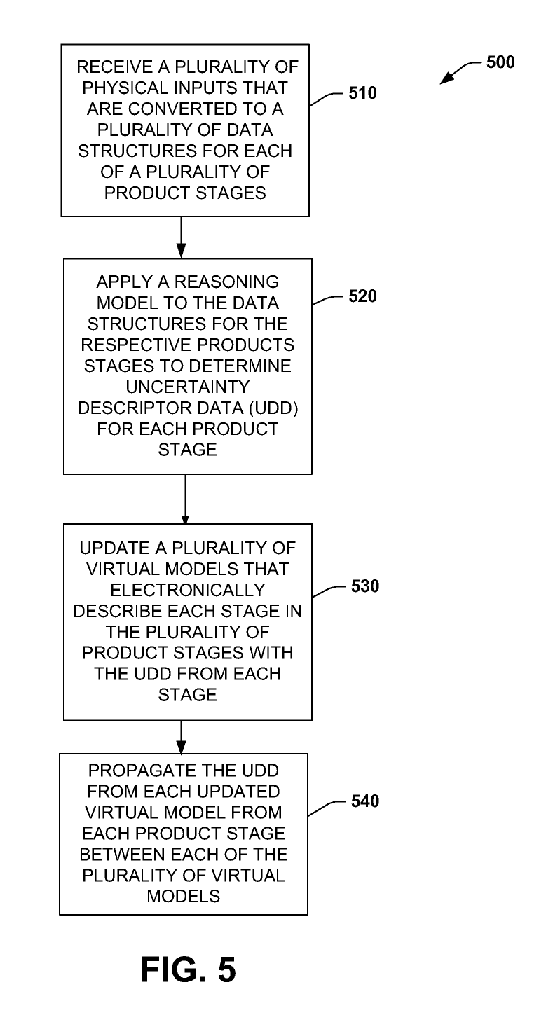

In view of the foregoing structural and functional features described above, an example method will be better appreciated with reference to FIG. 5. While, for purposes of simplicity of explanation, the method is shown and described as executing serially, it is to be understood and appreciated that the method is not limited by the illustrated order, as parts of the method could occur in different orders and/or concurrently from that shown and described herein. Such method can be executed by various components configured in an integrated circuit, processor, or a controller, for example.

FIG. 5 illustrates an example of a method 500 for concurrent uncertainty management where uncertainty data is processed at each stage of a product lifecycle. The method 500 includes receiving a plurality of data structures that represents a plurality of physical input data associated with product materials, assemblies, and operational use of a product of interest (e.g., via physical layer 110 of FIG. 1). The plurality of data structures include data structures for each of a design stage, a manufacturing stage, and a sustainment stage, the physical input data associated with each stage contributing to define an operational lifetime of a product. The method 500 includes applying a respective reasoning model to the data structures for the respective products stages to determine uncertainty descriptor data (UDD) for each product stage at 520 (e.g., via reasoning model layer 130 of FIG. 1).

The UDD defines an uncertainty probability estimate for each of the physical inputs in the plurality of data structures. The uncertainty probability estimate relates to the probability of error within each stage of the product lifetime. The method 500 includes updating a plurality of virtual models that electronically describe each stage in the plurality of product stages with the UDD from each stage at 530 (e.g., via propagation layer 140 of FIG. 1). The method 500 includes propagating the UDD from each updated virtual model from each product stage between each of the plurality of virtual models across a network to mitigate compounding of error estimates across each product stage of the product lifetime (e.g., via tagged identifiers 150 of FIG. 1).

Although not shown, the method 500 can also include applying at least one learning model to process the data structures, the at least one learning model includes at least one of a Bayesian learning model or a neural network. This can include overlaying a belief network on cause-and-effect structure in the data structures to propagate dominant uncertainties from their respective sources to respective product parameters of interest. This can also include processing random variable distributions that are represented at nodes in the belief network, the nodes having associated hyper-parameters that are updated using Bayesian learning. The method 500 can also include processing the random variable distributions to generate a probabilistic certification of correctness, a distribution for schedule, a distribution for cost, a distribution for performance, and a distribution for reliability. This can also include propagating the UDD via tagged identifiers that describe a common data model structure such that each virtual model can identify each component and process that has changed its probability from at least one other virtual model.

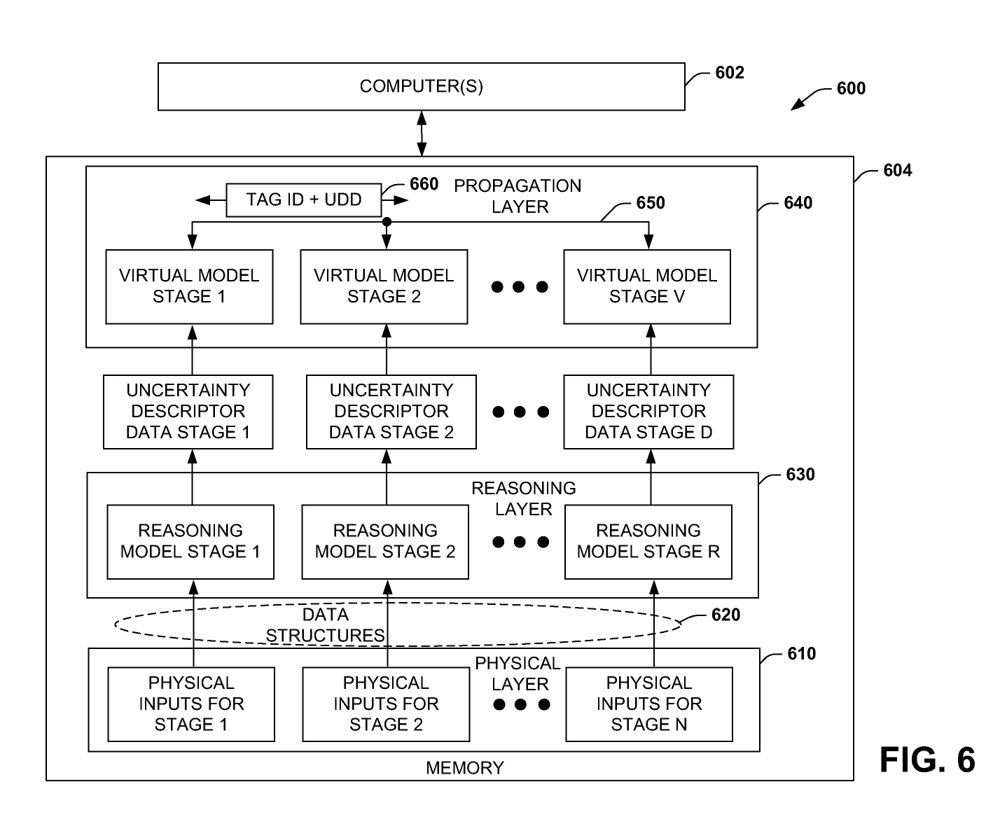

FIG. 6 illustrates an example processing framework for a concurrent uncertainty management system 600 where uncertainty data is processed at each stage of a product lifecycle to extend product lifetime. The system 600 includes one or more computers 602 which execute computer executable instructions from a memory 604 (or memories). At 610, the instructions can be configured to aggregate a plurality of data structures that represents a plurality of physical input data associated with product materials, assemblies, and operational use of a product of interest. The plurality of data structures include data structures for each of a design stage, a manufacturing stage, and a sustainment stage, for example, where the physical input data associated with each stage contributes to define an operational lifetime of a product

The instructions are configured to apply a respective reasoning model at 630 to the data structures for the respective products stages to determine uncertainty descriptor data (UDD) for each product stage. The UDD defines an uncertainty probability estimate for each of the physical inputs in the plurality of data structures. The uncertainty probability estimate relates to the probability of error within each stage of the product lifetime. The instructions are configured to update a plurality of virtual models that electronically describe each stage in the plurality of product stages with the UDD from each stage. At 640, the instructions are also configured to propagate the UDD from each updated virtual model from each product stage between each of the plurality of virtual models across a network 650 to mitigate compounding of error estimates across each product stage of the product lifetime. The UDD is propagated via tagged identifiers 660 that describe a common data model structure such that each virtual model can identify each component and process that has changed from at least one other virtual model to generate an extended product lifetime estimate. This can also include instructions to overlay a belief network on cause-and-effect structure in the data structures to propagate dominant uncertainties from their respective sources to respective product parameters of interest.

What has been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A system, comprising:
one or more computers executing computer executable components, the computer executable components comprising:
a physical layer that aggregates a plurality of data structures that represents a plurality of physical input data associated with product materials, assemblies, and operational use of a product of interest, wherein the plurality of data structures include data structures for each of a design stage, a manufacturing stage, and a sustainment stage, the physical input data associated with each stage contributing to define an operational lifetime of a product;
a reasoning model layer to process the data structures for the respective products stages to determine uncertainty descriptor data (UDD) for each product stage, the UDD defining an uncertainty probability estimate for each of the physical inputs in the plurality of data structures, the uncertainty probability estimate relates to the probability of error within each stage of the product lifetime; and
a propagation layer that employs a plurality of virtual models that electronically describe each stage in the plurality of product stages with the UDD from each stage and propagates the UDD from each updated virtual model from each product stage between each of the plurality of virtual models across a network to mitigate compounding of error estimates across each product stage of the product lifetime to provide a product lifetime estimate.

2. The system of claim 1, wherein the reasoning model layer includes at least one learning model to process the data structures, the at least one learning model includes at least one of a Bayesian learning model or a neural network.

3. The system of claim 2, wherein the Bayesian learning model includes a dynamic Bayesian belief network that is overlaid on cause-and-effect structure in the data structures to propagate dominant uncertainties from their respective sources to respective product parameters of interest.

4. The system of claim 3, further comprising random variable distributions that are represented at nodes in the Bayesian belief network, the nodes having associated hyper-parameters that are updated using Bayesian learning methods.

5. The system of claim 4, wherein the random variable distributions are processed to generate a probabilistic certification of correctness, a distribution for schedule, a distributions for cost, a distribution for performance, and a distribution for reliability.

6. The system of claim 1, wherein the UDD is propagated via tagged identifiers that describe a common data model structure such that each virtual model can identify each component and process that has changed its probability from at least one other virtual model.

7. The system of claim 1, wherein the UDD is computed as aleatoric uncertainty that describes inherent variation in a system, an epistemic uncertainty that describes a potential product deficiency, or a prejudicial uncertainty resulting from errors in biases or measurements in the system.

8. The system of claim 1, the virtual models further comprising manufacturing process models having controllable and random variables as inputs and output a resultant material microstructure.

9. The system of claim 8, the manufacturing process model includes a molecular dynamics (MD) composite cure model that takes a spatial distribution in temperature and pressure from a curing simulation and returns chemical and rheological characteristics of the matrix material including cure time, porosity, and degree of cross-linking.

10. The system of claim 8, further comprising a structure-property model that receives microstructure output from the manufacturing process model and outputs relevant nonlinear material properties, the structure-property model models nonlinear micromechanics behavior of composite materials to determine stochastic effects on the micro-scale and to capture physical, statistical and model uncertainties to predict failure at a sub-ply level.

11. The system of claim 10, further comprising a property-performance model to receive output from the structure-property model to predict component performance in its operational environment, wherein property-performance model performs probabilistic structural analysis of component to determine scatter in failure load and identify stages of damage and fracture evolution and probability of failure.

12. The system of claim 11, further comprising an interface to observe changes in each phase of the operational lifetime of the product as the UDD is updated in each virtual model.

13. A computer implemented method, comprising:
receiving a plurality of data structures that represents a plurality of physical input data associated with product materials, assemblies, and operational use of a product of interest, wherein the plurality of data structures include data structures for each of a design stage, a manufacturing stage, and a sustainment stage, the physical input data associated with each stage contributing to define an operational lifetime of a product;
applying a respective reasoning model to the data structures for the respective products stages to determine uncertainty descriptor data (UDD) for each product stage, the UDD defining an uncertainty probability estimate for each of the physical inputs in the plurality of data structures, the uncertainty probability estimate relates to the probability of error within each stage of the product lifetime;
updating a plurality of virtual models that electronically describe each stage in the plurality of product stages with the UDD from each stage; and
propagating the UDD from each updated virtual model from each product stage between each of the plurality of virtual models across a network to mitigate compounding of error estimates across each product stage of the product lifetime.

14. The method of claim 13, further comprising applying at least one learning model to process the data structures, the at least one learning model includes at least one of a Bayesian learning model or a neural network.

15. The method of claim 14, further comprising overlaying a belief network on cause-and-effect structure in the data structures to propagate dominant uncertainties from their respective sources to respective product parameters of interest.

16. The method of claim 15, further comprising processing random variable distributions that are represented at nodes in the belief network, the nodes having associated hyper-parameters that are updated using Bayesian learning.

17. The method of claim 16, further comprising processing the random variable distributions to generate a probabilistic certification of correctness, a distribution for schedule, a distributions for cost, a distribution for performance, and a distribution for reliability.

18. The method of claim 13, further comprising propagating the UDD via tagged identifiers that describe a common data model structure such that each virtual model can identify each component and process that has changed its probability from at least one other virtual model.

19. A non-transitory computer readable medium having computer executable instructions stored thereon, the instructions configured to:
aggregate a plurality of data structures that represents a plurality of physical input data associated with product materials, assemblies, and operational use of a product of interest, wherein the plurality of data structures include data structures for each of a design stage, a manufacturing stage, and a sustainment stage, the physical input data associated with each stage contributing to define an operational lifetime of a product;
apply a respective reasoning model to the data structures for the respective products stages to determine uncertainty descriptor data (UDD) for each product stage, the UDD defining an uncertainty probability estimate for each of the physical inputs in the plurality of data structures, the uncertainty probability estimate relates to the probability of error within each stage of the product lifetime;
update a plurality of virtual models that electronically describe each stage in the plurality of product stages with the UDD from each stage; and
propagate the UDD from each updated virtual model from each product stage between each of the plurality of virtual models across a network to mitigate compounding of error estimates across each product stage of the product lifetime, wherein the UDD is propagated via tagged identifiers that describe a common data model structure such that each virtual model can identify each component and process that has changed its probability from at least one other virtual model to generate a product lifetime estimate.

20. The computer readable medium of claim 19, further comprising instructions to overlay a belief network on cause-and-effect structure in the data structures to propagate dominant uncertainties from their respective sources to respective product parameters of interest.
